(19) United States
(12) Patent Application Publication
(10) Pub. No.: US 2026/0301762 A1
(43) Pub. Date: Oct. 1, 2026

(54) SOUND EXTRACTION METHOD, SOUND EXTRACTION SYSTEM, AND PROGRAM

(71) Applicant: KYOCERA Corporation, Kyoto (JP)

(72) Inventors: Takayuki ARAKAWA, Yokohama-shi (JP); Kengo OHARA, Yokohama-shi (JP); Kousuke OSUMI, Yokohama-shi (JP)

(73) Assignee: KYOCERA Corporation, Kyoto (JP)

(21) Appl. No.: 19/577,929

(22) Filed: Mar. 25, 2026

(30) Foreign Application Priority Data
Mar. 26, 2025 (JP) 2025-052530

(51) Int. Cl. G10L 25/51; H04R 1/40; H04R 3/00

(52) U.S. Cl. CPC G10L 25/51; H04R 1/406; H04R 3/005

(57) ABSTRACT

This sound extraction system includes an acquisition unit and a controller. The acquisition unit is configured to acquire detection sound sampled at each of a plurality of positions. The controller is configured to execute a first classification based on a sound type with respect to at least one sound component included in the detection sound. The controller is configured to execute a second classification based on a direction of arrival with respect to at least one sound component included in the detection sound. The controller is configured to extract, from the detection sound, a sound component that corresponds to the sound type and/or the direction of arrival identified on the basis of a classification result of the first classification and a classification result of the second classification.

### CROSS REFERENCE TO RELATED APPLICATION

The present invention contains subject matter related to Japanese Patent Application No. 2025-052530 filed in the Japan Patent Office on Mar. 26, 2025, the entire contents of which are incorporated herein by reference.

### BACKGROUND OF THE INVENTION

### 1. Field of the Invention

The present invention relates to a sound extraction method, a sound extraction system, and a program.

### 2. Description of the Related Art

The ability to emphasize sound emitted from a sound source of interest from among sampled sound and/or speech, thus allowing the emphasized sound to be heard, is desirable. A proposed mask calculation device extracts features from an observed signal of a voice or voices, calculates a mask for extracting the voice of a speaker of interest from the observed signal on the basis of the features and a signal of the voice of the speaker of interest, and uses the mask to calculate a signal of the voice of the speaker of interest (see International Publication No. 2019/017403).

### SUMMARY OF THE INVENTION

In a first aspect, the present disclosure provides a sound extraction method to be executed by a computer. The sound extraction method includes acquiring detection sound detected by a plurality of microphones. The sound extraction method includes executing a first classification based on a sound type with respect to at least one sound component included in the detection sound. The sound extraction method includes executing a second classification based on a direction of arrival of the sound with respect to at least one sound component included in the detection sound. The sound extraction method includes extracting, from the detection sound, a sound component that corresponds to a sound type identified by the first classification and/or a sound component that corresponds to a direction of arrival identified by the second classification.

In a second aspect, the present disclosure provides a sound extraction system. The sound extraction system includes an acquisition unit and a controller. The acquisition unit is configured to acquire detection sound sampled at each of a plurality of positions. The controller is configured to execute a first classification based on a sound type with respect to at least one sound component included in the detection sound. The controller is configured to execute a second classification based on a direction of arrival of the sound with respect to at least one sound component included in the detection sound. The controller is configured to extract, from the detection sound, a sound component that corresponds to a sound type identified by the first classification and/or a sound component that corresponds to a direction of arrival identified by the second classification.

In a third aspect, the present disclosure provides a program. The program causes a computer to execute a process. The process includes acquiring detection sound detected by a plurality of microphones. The process includes executing a first classification based on a sound type with respect to at least one sound component included in the detection sound. The process includes executing a second classification based on a direction of arrival of the sound with respect to at least one sound component included in the detection sound. The process includes extracting, from the detection sound, a sound component that corresponds to a sound type identified by the first classification and/or a sound component that corresponds to a direction of arrival identified by the second classification.

### BRIEF DESCRIPTION OF THE DRAWINGS

FIG. 1 is a functional block diagram illustrating a schematic configuration of a sound extraction system according to a first embodiment;

FIG. 2 is a conceptual exterior view of earphones provided with the speakers and the microphones in FIG. 1;

FIG. 3 is a first image to be displayed on the output unit in FIG. 1;

FIG. 4 is a second image to be displayed on the output unit in FIG. 1;

FIG. 5 is a flowchart for explaining a volume adjustment process to be executed by the controller in FIG. 1;

FIG. 6 is a functional block diagram illustrating a schematic configuration of a sound extraction system according to a second embodiment;

FIG. 7 is a third image to be displayed on the output unit in FIG. 6;

FIG. 8 is a fourth image to be displayed on the output unit in FIG. 6; and

FIG. 9 is a table indicating deemed combinations of sound types and directions of arrival that are deemed to correspond to the same sound components when sound components emitted by a plurality of sound sources are included in detection sound.

### DESCRIPTION OF THE PREFERRED EMBODIMENTS

The following refers to the drawings to describe embodiments of a sound extraction method to which the present disclosure is applied.

A sound extraction system capable of executing a sound extraction method according to a first embodiment of the present disclosure is configured to include an acquisition unit and a controller. The acquisition unit is configured to acquire detection sound sampled at each of a plurality of positions. The acquisition unit may acquire detection sound by detection or by reception of a signal from external equipment through communication. In the present embodiment, the acquisition unit may be a communication unit that acquires detection sound by reception of a signal as information.

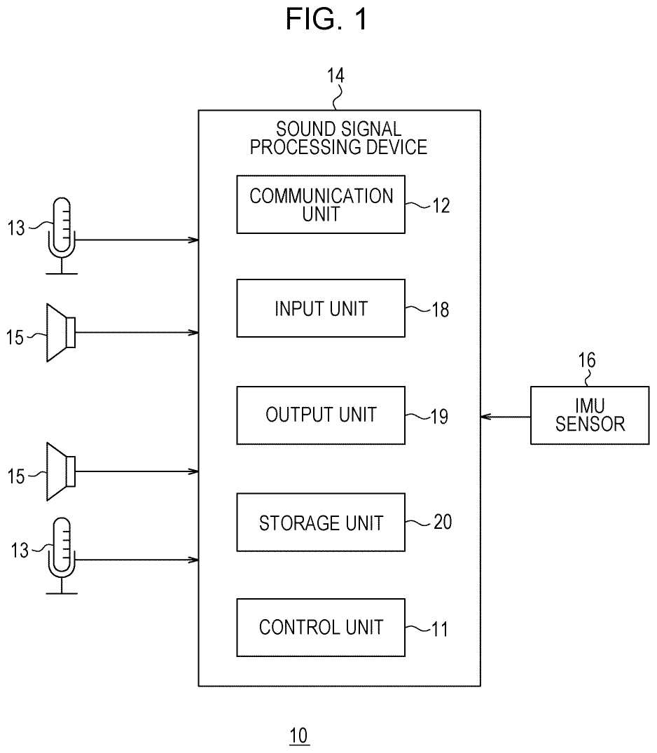

As illustrated in FIG. 1, a sound extraction system 10 may include a plurality of microphones 13, a sound signal processing device 14, at least one speaker 15, and an IMU sensor 16. In this configuration, a communication unit 12 and a controller 11 may be provided in the sound signal processing device 14. The at least one speaker 15 may be a plurality of speakers 15.

The plurality of microphones 13 may be located at different positions. The plurality of microphones 13 may detect the same sound at each of a plurality of positions as detection sound. Each microphone 13 may detect audible sound. However, each microphone 13 is not limited to audible sound and may also perform sampling of sound at 40 kHz or higher to detect sound in the ultrasonic region.

Each microphone 13 may transmit an unmodified analog sound signal corresponding to detected detection sound to the sound signal processing device 14. Each microphone 13 may convert an analog sound signal corresponding to detected detection sound into digital sound data and transmit the digital sound data to the sound signal processing device 14.

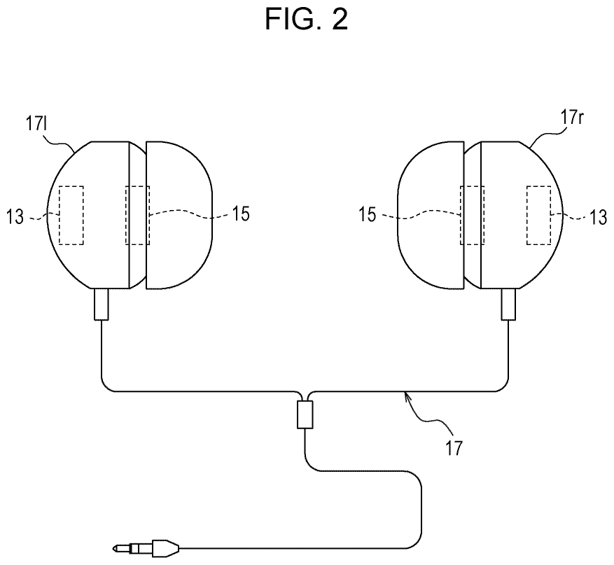

The speaker 15 may acquire sound generated by the sound signal processing device 14 as a signal. The speaker 15 may emit the acquired sound. The speaker 15 may be provided with earphones 17, as illustrated in FIG. 2, or headphones. In the earphones 17, the speaker 15 may be provided in each of a right-ear earpiece 17r and a left-ear earpiece 171. The microphones 13 may be provided in the right-ear earpiece 17r and the left-ear earpiece 171, respectively.

The IMU sensor 16 may detect acceleration and angular velocity on three mutually orthogonal axes. The IMU sensor 16 is assumed to be worn by a user, and may be provided to the earphones 17 described above, for example. While being worn by the user, the IMU sensor 16 may detect acceleration and angular velocity as the user moves.

The sound signal processing device 14 may be achieved as a special-purpose device such as a hearing aid or a sound collector, for example. The sound signal processing device 14 may be achieved as a portable terminal such as a smartphone that executes a program for executing a sound extraction method according to the present disclosure, for example.

As illustrated in FIG. 1, the sound signal processing device 14 is configured to include the communication unit 12 and the controller 11, as described above. The sound signal processing device 14 may be configured to further include an input unit 18, an output unit 19, and a storage unit 20.

The communication unit 12 may be capable of communicating with the microphones 13 and the speaker 15 through a communication link configured to include a wired line or a wireless channel. The communication unit 12 may acquire detection sound detected by the plurality of microphones 13 in the form of an analog signal or digital data. The communication unit 12 may transmit detection sound generated by the controller 11 to the speaker 15 as information.

The input unit 18 may include at least one input interface that detects operational input by the user. The input interface may be a physical key, a capacitive key, a pointing device, a touchscreen integrally provided with a display of the output unit 19, a microphone, and/or an IMU sensor, for example.

The output unit 19 may include at least one output interface that outputs information to notify the user. The output interface may be a display that outputs information as an image and/or video, and/or a speaker that outputs information as sound and/or speech, for example. The display is a liquid crystal display (LCD) panel or an organic electroluminescence (EL) display panel, for example.

The storage unit 20 may include any of semiconductor memory, magnetic memory, and/or optical memory. The semiconductor memory is random-access memory (RAN) and/or read-only memory (ROM), for example. The RAM is static random-access memory (SRAM) and/or dynamic random-access memory (DRAM), for example. The ROM is electrically erasable programmable read-only memory (EEPROM), for example. The storage unit 20 may function as main memory, auxiliary memory, or cache memory. The storage unit 20 may store data to be used in operations by the sound signal processing device 14 and data obtained as a result of operations by the sound signal processing device 14. The storage unit 20 stores a system program, an application program, and/or embedded software, for example.

The controller 11 may be configured to include at least one processor, at least one special-purpose circuit, or a combination thereof. The processor is a general-purpose processor, such as a central processing unit (CPU) or a graphics processing unit (GPU), or a special-purpose processor specialized in specific processing. The special-purpose circuit may be a field-programmable gate array (FPGA) or an application-specific integrated circuit (ASIC), for example. The controller 11 may execute processing related to operations by the sound signal processing device 14 while controlling each unit of the sound signal processing device 14.

The controller 11 executes a first classification with respect to at least one sound component included in detection sound acquired in the communication unit 12. The first classification uses a sound type of each sound component as a basis to group sound components with similar sound types and categorize grouped sound components into at least one set. Specifically, in the first classification, the controller 11 may extract a feature specific to the sound type for each of at least one sound component included in detection sound respectively detected at the plurality of microphones 13.

Conceivable features to be extracted include the spectrogram power, the logarithmic spectrogram power, the Mel-frequency cepstral coefficients (MFCCs), embedding features extracted using a neural network, and/or the like.

These features may be computed as vector quantities at intervals of a short time unit, such as every 10 milliseconds, for example.

The controller 11 executes a second classification with respect to at least one sound component included in detection sound acquired in the communication unit 12. The second classification uses a direction of arrival of each sound component as a basis to group sound components with similar directions of arrival and categorize grouped sound components into at least one set. Specifically, in the second classification, the controller 11 may extract characteristics such as the time difference and the phase difference of the arrival, at each of the microphones 13, of detection sound respectively detected at the plurality of microphones 13. The controller 11 may extract these characteristics as features specific to the direction of arrival.

Conceivable features to be extracted include the cross-correlation of time series of sound between the microphones 13, the cross-spectrum, embedding features extracted using a neural network that accepts a time series of sound signals between the microphones 13 as input, and/or the like. These features may be computed as vector quantities at intervals of a short time unit, such as every 10 milliseconds, for example.

The controller 11 extracts, from detection sound, a sound component that corresponds to both a sound type and a direction of arrival identified on the basis of a classification result of the first classification and a classification result of the second classification. The following describes in detail the identification of sound type and direction of arrival and the extraction from detection sound.

The controller 11 may estimate a sound type specific to the sound component on the basis of a classification result of the first classification. Specifically, the controller 11 may estimate a sound type through a comparison between a classification result of the first classification and a classification result of the first classification specific to a given sound type. In the first embodiment, the controller 11 may estimate a sound type through a comparison between a feature extracted by the first classification and a feature specific to a given sound type.

In a configuration in which features are computed as vector quantities as described above, the controller 11 may compute the distance between an extracted feature and a feature specific to a given sound type, and estimate that the given sound type for which the distance is the smallest, or the given sound type for which the distance is not more than a first distance threshold value, is the sound type of a sound component included in detection sound.

The controller 11 may estimate the sound type of a sound component included in detection sound on the basis of a similarity between an extracted feature and a feature specific to a given sound type. The similarity may be the cosine similarity, for example. The controller 11 may estimate the sound type of a sound component included in detection sound by using a neural network that has been trained on the features to be extracted.

A feature specific to a given sound type may be extracted from sound sampled in advance, and may be stored in the storage unit 20. Given sound types may be sound types categorized in a semantically understandable way, or may be sound types categorized automatically by clustering sound type-specific features for each of a large number of collected sound sources according to distance.

Sound types categorized in a semantically understandable way may be male voice, female voice, animal cry, machine sound, and sound of running water, for example. Any granularity of categorization and any number of classes may be employed. Features of given sound types may be editable, and each may be replaced, removed, or added. The voice of a specific individual may be registered to a given sound type. For example, an announcement sound played through a loudspeaker may be registered. For example, a sound indicating emotion, such as laughter or crying, may be registered.

Methods for categorizing sound types automatically by clustering include k-means clustering, for example. In this way, any number of clusters may be used for categorization, even in a configuration in which sound types are categorized automatically. The number of sound types and the method of categorization may be customized according to user convenience, way of use, and/or the like.

The controller 11 may estimate a direction of arrival specific to the sound component on the basis of a classification result of the second classification.

Specifically, the controller 11 may estimate a direction of arrival through a comparison between a classification result of the second classification and a classification result of the second classification specific to a given direction of arrival. In the first embodiment, the controller 11 may estimate a direction of arrival through a comparison between a feature extracted by the second classification and a feature specific to a given direction of arrival. In the second classification, a direction of arrival that includes the distance from the user may be estimated.

In a configuration in which features are computed as vector quantities as described above, the controller 11 may compute the distance between an extracted feature and a feature specific to a given direction of arrival, and estimate that the given direction of arrival for which the distance is the smallest, or the given direction of arrival for which the distance is not more than a second distance threshold value, is the direction of arrival of a sound component included in detection sound.

A feature specific to a given direction of arrival may be extracted from sound sampled in advance, and may be stored in the storage unit 20. Given directions of arrival may be the four directions to the front, the rear, the left, and the right of the user, or may be directions delimited at intervals of 10°. In a configuration in which the distance from the user is also combined with the direction of arrival in the second classification as described above, the given directions of arrival may include a categorization of the distance from the user, such as less than 1 m, 1 m or more and less than 3 m, and 3 m or more.

The controller 11 may estimate a sound type and a direction of arrival that correspond to the same sound component on the basis of a classification result of the first classification and a classification result of the second classification. Specifically, the controller 11 may estimate that the combination of a sound type estimated by the first classification and a direction of arrival estimated by the second classification is the combination of a sound type and a direction of arrival that correspond to the same sound component included in detection sound.

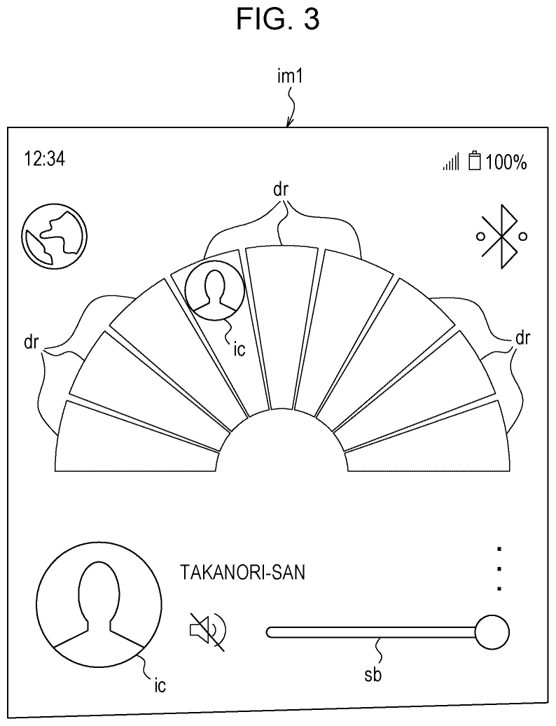

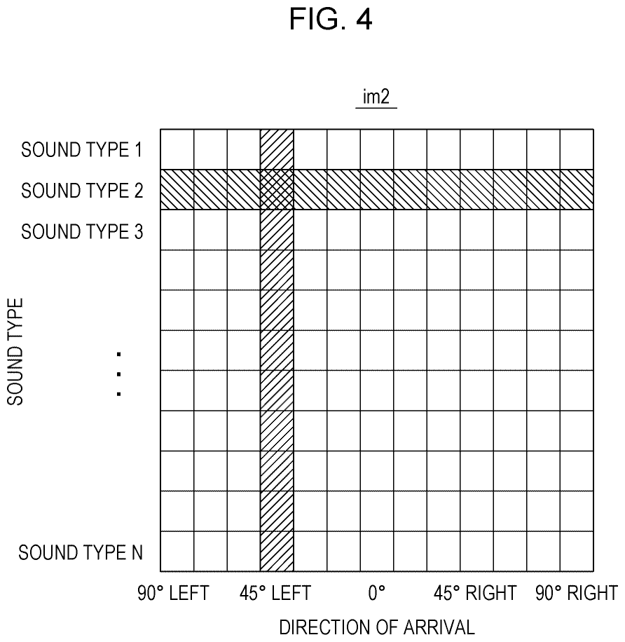

The controller 11 may present, via the output unit 19, at least one sound type estimated by the first classification and at least one direction of arrival estimated by the second classification. In a configuration in which the output unit 19 is a display, the controller 11 may control the output unit 19 to display a first image im1, as illustrated in FIG. 3. The controller 11 may control the output unit 19 to display a second image im2, as illustrated in FIG. 4.

As illustrated in FIG. 3, in the first image im1, a plurality of fan-shaped direction ranges dr segmented within a forward-focused semicircle centered on the user may be drawn. The ranges of the direction ranges dr may correspond to the given directions of arrival. For example, the angle of each direction range dr may be the same as the angle between two given directions of arrival that are adjacent to one another in the circumferential direction. In the first image im1, the direction ranges dr may be drawn in a different form. For example, each direction range dr may be drawn so as to correspond with one of the directions to the front, the rear, the left, or the right centered on the user.

In the first image im1, a sound type and a direction of arrival that correspond to the same sound component may be drawn. For example, a pictorial representation ic indicating a sound type estimated by the first classification may be drawn inside the direction range dr that corresponds to a direction of arrival estimated by the second classification, thereby indicating a deemed combination of a sound type and a direction of arrival that correspond to the same sound component. The pictorial representation is an icon, for example.

In the first image im1, a sound type estimated by the first classification may be drawn irrespectively of the direction of arrival. For example, a pictorial representation ic that corresponds to the sound type may be drawn below the direction ranges dr in the first image im1. In a configuration in which a pictorial representation ic is drawn outside the direction ranges dr, a volume adjustment bar sb may be drawn beside the pictorial representation ic.

In the first image im1, a direction of arrival estimated by the second classification may be drawn irrespectively of the sound type. For example, the direction range dr that corresponds to a direction of arrival estimated by the second classification may be drawn in a form different from that of the other direction ranges dr. Specifically, the direction range dr that corresponds to a direction of arrival estimated by the second classification may be drawn in a color different from that of the other direction ranges dr.

As described above, in a configuration in which a direction of arrival classified by distance from the user is estimated, the direction ranges dr may be segmented according to the distance from the center of the semicircle. In this configuration, the direction range dr segment that corresponds to the direction of arrival and the distance estimated by the second classification may be drawn in a form different from that of the other direction range dr segments.

As illustrated in FIG. 4, in the second image im2, a table indicating sound types and directions of arrival may be drawn. In this table, sound type may be represented on the vertical axis and direction of arrival may be represented on the horizontal axis. In the second image im2, the row of a sound type estimated by the first classification may be drawn in a form different from that of the other rows. In the second image im2, the column of a direction of arrival estimated by the second classification may be drawn in a form different from that of the other columns. In the second image im2, a deemed combination of a sound type and a direction of arrival that correspond to the same sound component may be indicated by the region where the row of a sound type estimated by the first classification intersects with the column of a direction of arrival estimated by the second classification.

The presentation of an estimated direction of arrival is not limited to being a pictorial representation on a display as an image, and may be achieved by other means. For example, in a configuration in which the output unit 19 is a plurality of piezoelectric elements, the controller 11 may present a direction of arrival by vibrating the piezoelectric elements in correspondence with the direction of arrival. As another example, in a configuration in which the output unit 19 is a speaker, the controller 11 may present a direction of arrival and a sound type through the playback of sound and/or speech.

The controller 11 may recognize selection input that the input unit 18 detects with respect to the presentation of a sound type and a direction of arrival. In a configuration in which the input unit 18 is a touchscreen, selection input of a sound type and a direction of arrival that correspond to the same sound component may be detected in response to contact with a pictorial representation ic, which is drawn so as to be superimposed on a direction range dr in the first image im1 displayed on the display.

Selection input of a sound type may be detected in response to contact with a pictorial representation ic in the first image im1. Selection input of a direction of arrival may be detected in response to contact with a direction range dr in the first image im1. Selection input of a sound type and a direction of arrival that correspond to the same sound component may be detected in response to contact with a point on a table in the second image im2 displayed on the display. Selection input of a sound type may be detected in response to sliding along any row indicating a sound type in the second image im2. Selection input of a direction of arrival may be detected in response to sliding along any column indicating a direction of arrival in the second image im2 displayed on the display.

In a configuration in which the input unit 18 is a plurality of physical keys or a plurality of capacitive keys, selection input of a sound type or a direction of arrival assigned to any physical key or any capacitive key may be detected in response to pressing of the respective physical key or the respective capacitive key. In a configuration in which the input unit 18 is an IMU sensor expected to be worn on the head, selection input of a sound type or a direction of arrival associated with a specific direction may be detected in response to tilting of the head in the specific direction. In a configuration in which the input unit 18 is a microphone, selection input of a sound type and a direction of arrival may be detected in response to an utterance of the user.

The controller 11 may identify, according to selection input, a sound type and/or a direction of arrival corresponding to a sound component extracted from detection sound. The controller 11 extracts, from detection sound, a sound component that corresponds to the identified sound type and/or a sound component that corresponds to the identified direction of arrival. The controller 11 may extract, from detection sound, a sound component that corresponds to both a sound type and a direction of arrival identified on the basis of a classification result of the first classification and a classification result of the second classification.

The controller 11 may adjust the volume of a sound component extracted from detection sound relative to the detection sound excluding the extracted sound component, or in other words, the other sound components. The controller 11 may raise the volume of the extracted sound component relative to the other sound components by raising the volume of the extracted sound component. The controller 11 may raise the volume of the extracted sound component relative to the other sound components by lowering the volume of the other sound components. The controller 11 may raise the volume of the extracted sound component relative to the other sound components by both raising the volume of the extracted sound component and lowering the volume of the other sound components. The controller 11 may perform volume adjustment by multiplying detection sound by a coefficient computed by a neural network, for example.

The controller 11 may also adjust a volume step size for volume adjustment. For example, in a configuration in which the input unit 18 is a touchscreen, the controller 11 may adjust the volume to be a relative volume in accordance with a final contact location on the volume adjustment bar sb. For example, if the same selection input is detected, the controller 11 may adjust the volume by a step size in accordance with the number of times the selection input is detected. The controller 11 may also reset volume adjustment. For example, the controller 11 may reset volume adjustment on the basis of detection of a head-shaking gesture in a configuration in which the input unit 18 is an IMU sensor, or on the basis of detection of a reset or other voice command in a configuration in which the input unit 18 is a microphone.

The controller 11 may control the speaker 15 to output volume-adjusted detection sound.

The controller 11 may compute a change in the position and orientation of the user on the basis of an acceleration and an angular velocity detected by the IMU sensor 16. The controller 11 may compute a relative change in an estimated direction of arrival according to a change in the position and orientation. The controller 11 may correct an identified direction of arrival according to a relative change in the direction of arrival.

The controller 11 may compute a variance value as a result of classification of sound types and directions of arrival within a prescribed time range, or in other words, for each of a plurality of sound-type features and a plurality of direction-of-arrival features that are extracted within the prescribed time range. The controller 11 may widen the range of a specific sound type or a direction of arrival according to the magnitude of the variance value.

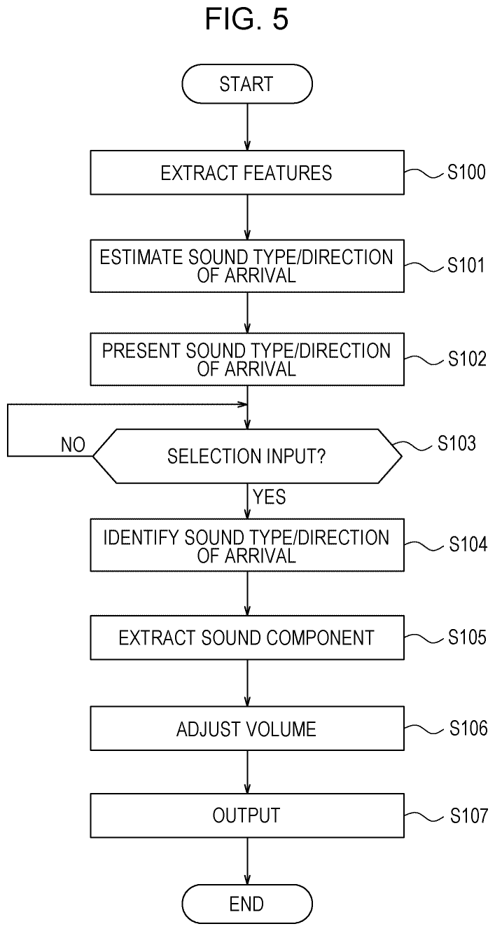

The following uses the flowchart in FIG. 5 to describe a volume adjustment process to be executed by the controller 11 of the sound signal processing device 14 in the first embodiment. The volume adjustment process starts when the microphone 13 detects sound, for example.

In step S100, the controller 11 extracts a feature specific to the sound type by performing the first classification on at least one sound component included in detection sound acquired from the microphone 13. The controller 11 extracts a feature specific to the direction of arrival by performing the second classification on at least one sound component included in the detection sound. After extraction, the process advances to step S101.

In step S101, the controller 11 estimates a sound type specific to the sound component included in detection sound and a direction of arrival specific to the sound component included in detection sound on the basis of the features extracted in step S100. After estimation, the process advances to step S102.

In step S102, the controller 11 controls the output unit 19 to present the sound types and the directions of arrival estimated in step S101. After presentation of the sound types and the directions of arrival, the process advances to step S103.

In step S103, the controller 11 determines whether the input unit 18 has detected selection input. If selection input is not detected, the process advances to step S103. If selection input is detected, the process advances to step S104.

In step S104, the controller 11 identifies, on the basis of the selection input detected in step S103, a sound type and a direction of arrival to be extracted. After identification, the process advances to step S105.

In step S105, the controller 11 extracts, from detection sound, the sound component that corresponds to each of the sound type and the direction of arrival identified in step S104. After extraction, the process advances to step S106.

In step S106, the controller 11 relatively adjusts the volume of the sound component extracted in step S105. After adjustment, the process advances to step S107.

In step S107, the controller 11 causes the speaker 15 to output detection sound containing the sound component of which the volume was adjusted in step S106. After output, the volume adjustment process ends.

The sound extraction system 10 according to the first embodiment with a configuration like the above is provided with the communication unit 12 and the controller 11. The communication unit 12 is configured to acquire detection sound sampled at each of a plurality of positions. The controller 11 is configured to execute a first classification based on a sound type with respect to at least one sound component included in the detection sound. The controller 11 is configured to execute a second classification based on a direction of arrival of the sound with respect to at least one sound component included in the detection sound. The controller 11 is configured to extract, from the detection sound, a sound component that corresponds to both a sound type and a direction of arrival identified on the basis of a classification result of the first classification and a classification result of the second classification. Such a configuration may allow for the sound extraction system 10 to exhibit an improvement in the precision of isolating a desired sound component, because the desired sound component corresponds to the identified sound type and direction of arrival.

In the first embodiment, the sound extraction system 10 is configured to relatively adjust the volume of the extracted sound component. Such a configuration may allow for the sound extraction system 10 to cause the user to perceive a desired sound component distinctly.

In the first embodiment, the sound extraction system 10 is configured to present at least one sound type estimated by the first classification and at least one direction of arrival estimated by the second classification. The sound extraction system 10 is configured to detect selection input with respect to the presentation of the at least one sound type and the at least one direction of arrival. The sound extraction system 10 is configured to identify a sound type and a direction of arrival in accordance with the selection input. Such a configuration may allow for the sound extraction system 10 to exhibit a further improvement in the precision of isolating a user-desired sound component, because the user can be prompted to select an estimated sound type and an estimated direction of arrival, and the sound type and the direction of arrival of the sound component that is to be extracted can be identified.

The following describes a sound extraction system according to a second embodiment of the present disclosure. In the second embodiment, the method for estimating and the method for presenting sound types and directions of arrival differ from those of the first embodiment. The following description of the second embodiment mostly focuses on the differences from the first embodiment. Portions having the same configuration as in the first embodiment are denoted with the same signs.

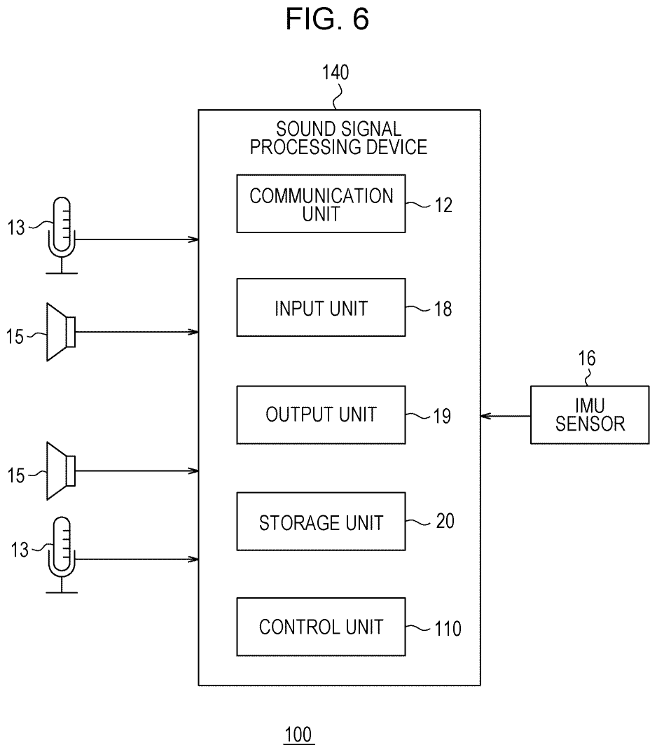

As illustrated in FIG. 6, in the second embodiment, a sound extraction system 100 may include a plurality of microphones 13, a sound signal processing device 140, and at least one speaker 15. In the second embodiment, the microphones 13 and the speaker 15 have the same configuration and function as in the first embodiment.

The sound signal processing device 140 is configured to include a communication unit 12 and a controller 110, as described above. The sound signal processing device 140 may be configured to further include an input unit 18, an output unit 19, and a storage unit 20. In the second embodiment, the communication unit 12, the input unit 18, the output unit 19, and the storage unit 20 have the same configuration and function as in the first embodiment.

Like in the first embodiment, the controller 110 may be configured to include at least one processor, at least one special-purpose circuit, or a combination thereof. In the same and/or similar way as in the first embodiment, the controller 110 may execute processing related to operations by the sound signal processing device 140 while controlling each unit of the sound signal processing device 140.

Like in the first embodiment, the controller 110 executes the first classification with respect to at least one sound component included in detection sound acquired in the communication unit 12. Specifically, like in the first embodiment, in the first classification, the controller 110 may extract a feature specific to the sound type for each sound component.

Like in the first embodiment, the controller 110 executes the second classification with respect to at least one sound component included in detection sound acquired in the communication unit 12. Specifically, in the second classification, the controller 110 may extract a feature specific to the direction of arrival for each sound component.

In the same and/or similar way as in the first embodiment, the controller 110 extracts, from detection sound, a sound component that corresponds to both a sound type and a direction of arrival identified on the basis of a classification result of the first classification and a classification result of the second classification. The following describes in detail the identification of sound type and direction of arrival and the extraction from detection sound.

In the same and/or similar way as in the first embodiment, the controller 110 may estimate a sound type specific to the sound component on the basis of a classification result of the first classification.

Specifically, unlike in the first embodiment, the controller 110 may estimate a sound type by computing a probability specific to a given sound type on the basis of a classification result of the first classification. More specifically, the controller 110 may estimate that a sound type having a probability that is in the top n1 probabilities specific to the sound type (where n1 is any natural number) or a sound type having a probability that is not less than a first probability threshold value is the sound type of a sound component included in detection sound.

The probability specific to the sound type may be computed from a distance between an extracted feature and a feature specific to a given sound type. The probability specific to the sound type may also be computed on the basis of similarity instead of distance. In the following, a distance-based computation method is described as a specific example.

The probability may be computed so that the lesser the distance between an extracted feature and a feature specific to a given sound type, the higher and closer to 1 the probability, and conversely, the greater the distance, the lower and closer to 0 the probability. For example, a sigmoid function or the softmax function may be used as the method for computing the probability from the distance. In a configuration in which a sigmoid function is used, the probability P(c) that detection sound is classified into a given sound type c may be computed according to the following expression (1).

$$[ Math . 1 ]$$

$$P = Sigmoid ( - w \times d\_c + b ) = \frac{1}{1 + {e}^{w \times d \_ c - b}} \qquad ( 1 )$$

In expression (1), d c is the distance between an extracted feature and a feature specific to a given sound type c, w is a weight, and b is a bias, which is a quantity for adjusting the dynamic range of the distance. The bias b may be set in advance using an approach such as machine learning.

In a configuration in which the softmax function is used, the probability P(c) may be computed according to expression (2).

$$[ Math . 2 ]$$

$$P ( c ) = Softmax ( - w \times d\_c + b ) = \frac{{e}^{- w \times d \_ c + b}}{{\sum }_{{c}^{′}} {e}^{- w \times {d \_ c}^{′} + b}} \qquad ( 2 )$$

The difference from a sigmoid function is that the probabilities respectively specific to all registered sound types c are normalized (so that the probabilities respectively specific to all sound types c add up to 1).

In the same and/or similar way as in the first embodiment, the controller 110 may estimate a direction of arrival specific to the sound component on the basis of a classification result of the second classification. Specifically, unlike in the first embodiment, the controller 110 may estimate a direction of arrival by computing a probability specific to a given direction of arrival on the basis of a classification result of the second classification. More specifically, the controller 110 may estimate that a direction of arrival having a probability that is in the top n2 probabilities specific to the direction of arrival (where n2 is any natural number) or a direction of arrival having a probability that is not less than a second probability threshold value is the direction of arrival of a sound component included in detection sound.

The probability specific to the direction of arrival may be computed from an extracted feature and a feature specific to a given direction of arrival, in the same and/or similar way as the probability specific to the sound type.

Unlike the first embodiment, the controller 110 may estimate a sound type and a direction of arrival that correspond to the same sound component on the basis of a classification result of the first classification and a classification result of the second classification. Specifically, the controller 110 may estimate a sound type and a direction of arrival that correspond to the same sound component on the basis of a joint probability distribution of a sound type that may be classified by the first classification and a direction of arrival that may be classified by the second classification. The following describes the joint probability distribution.

Let c be an index indicating a given sound type and let d be an index indicating a given direction of arrival, in which case P(c, d) represents the joint probability that a sound and/or speech signal included in detection sound is both c and d. By the multiplication theorem of probability, the joint probability P(c, d) may be computed by the product of the two probabilities and a conditional probability, as indicated in expressions (3) and (4).

$$P ( c , d ) = P ( c ) \times P ( d \vert c ) \qquad ( 3 )$$

$$P ( c , d ) = P ( d ) \times P ( c \vert d ) \qquad ( 4 )$$

In expression (3), P(c) is the probability that a sound component having the sound type c is included in the detection sound, and P(d|c) is the conditional probability that a sound component having the direction of arrival d is included in the detection sound under the condition that a sound component having the sound type c is included in the detection sound. In expression (4), P(d) is the probability that a sound component having the direction of arrival d is included in the detection sound, and P(c|d) is the conditional probability that a sound component having the sound type c is included in the detection sound under the condition that a sound component having the direction of arrival d is included in the detection sound.

To compute the conditional probability P(d|c), a conditional feature Fd indicative of a sound component with the direction of arrival d is computed. The conditional feature Fd is computed by weighting a feature fd pertaining to the direction of arrival by the probability P(c) that a sound component having the sound type c is included, and averaging in the time direction, as indicated in expression (5).

$$Fd = \sum \{ P ( c ) \times fd \div T \} \qquad ( 5 )$$

In expression (5), Σ indicates summation in the time direction. Also, T indicates the length of time over which to perform the summation. The conditional feature Fd computed according to expression (5) above can be regarded as a feature of a unit of time containing a sound component having the sound type c, selectively isolated and extracted from the original feature fd.

The conditional probability P(d|c) may be computed by calculating the distance between the conditional feature Fd and a feature of a given direction of arrival. A sigmoid function, the softmax function, or the like may be used to compute the conditional probability P(d|c).

In the same and/or similar way, to compute the conditional probability P(c|d), a conditional feature Fc indicative of a sound component having the sound type c may be computed. The conditional feature Fc is computed by weighting a feature fc pertaining to the sound type c by the probability P(d) that a sound component from the direction of arrival d is included, and averaging in the time direction. The conditional probability P(c|d) may be computed by calculating the distance between the conditional feature Fc and a feature specific to a given sound type.

The controller 110 may create a joint probability distribution through the computation of a joint probability P(c, d) specific to the combination of a given sound type and a given direction of arrival on the basis of a feature extracted by the first classification, a feature extracted by the second classification, a feature specific to the given sound type, and a feature specific to the given direction of arrival.

For example, the controller 110 may estimate that in the joint probability distribution, the top n3 combinations (where n3 is any natural number) each correspond to a sound type and a direction of arrival that correspond to the same sound component included in detection sound. For example, the controller 110 may estimate that in the joint probability distribution, a combination for which the joint probability is not less than a third probability threshold value corresponds to a sound type and a direction of arrival that correspond to the same sound component included in detection sound. For example, the controller 110 may estimate that in the joint probability distribution, a combination which is in the top n3 combinations and for which the joint probability is not less than the third probability threshold value corresponds to a sound type and a direction of arrival that correspond to the same sound component included in detection sound.

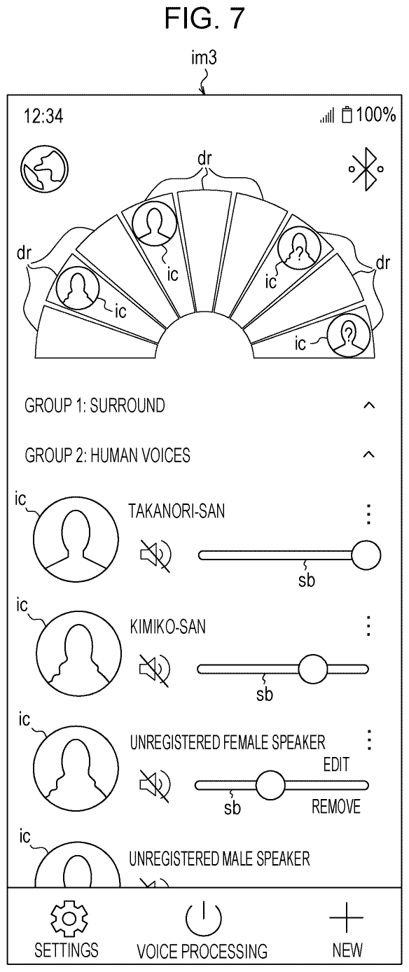

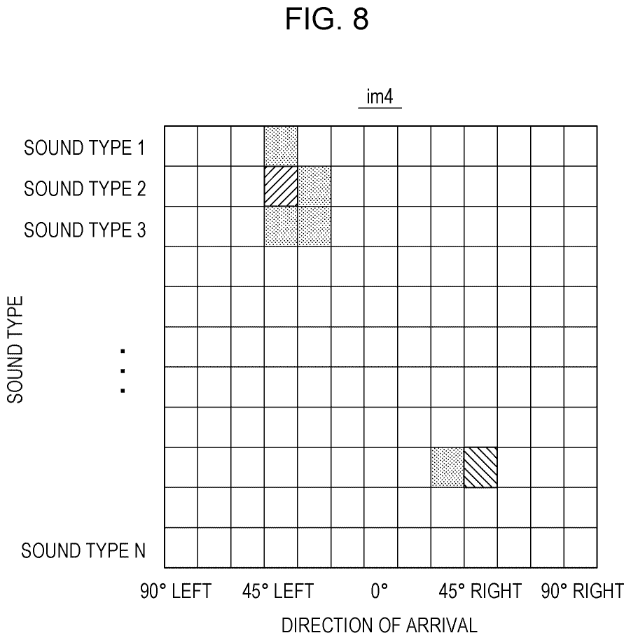

Like in the first embodiment, the controller 110 may present, via the output unit 19, at least one sound type estimated by the first classification and at least one direction of arrival estimated by the second classification. Unlike in the first embodiment, in a configuration in which the output unit 19 is a display, the controller 110 may control the output unit 19 to display a third image im3, as illustrated in FIG. 7. Unlike in the first embodiment, the controller 110 may control the output unit 19 to display a fourth image im4, as illustrated in FIG. 8.

As illustrated in FIG. 7, in the third image im3, like in the first image im1, a plurality of fan-shaped direction ranges dr segmented within a forward-focused semicircle centered on the user may be drawn. In the third image im3, in the same and/or similar way as in the first image im1, a sound type and a direction of arrival that correspond to the same sound component may be drawn. For example, for a combination of a sound type and a direction of arrival that are estimated to correspond to the same sound component, a pictorial representation ic corresponding to that sound type may be drawn inside the direction range dr corresponding to that direction of arrival.

In the third image im3, like in the first image im1, a sound type estimated by the first classification may be drawn irrespectively of the direction of arrival. In the third image im3, like in the first embodiment, a volume adjustment bar sb may be drawn. In the third image im3, like in the first image im1, a direction of arrival estimated by the second classification may be drawn irrespectively of the sound type.

As illustrated in FIG. 8, in the fourth image im4, in the same and/or similar way as in the second image im2, a table indicating sound types and directions of arrival may be drawn. In the fourth image im4, unlike in the second image im2, a joint probability may be drawn in individual regions delimited by rows and columns. Each region may be drawn in a different pattern depending on the magnitude of the joint probability to indicate the joint probability of the sound type and the direction of arrival that the region represents.

The control in the controller 110 for selection input after the presentation of an estimated sound type and an estimated direction of arrival, for extraction of a sound component, for volume adjustment, and for output of volume-adjusted detection sound is the same as and/or similar to the control in the first embodiment.

The sound extraction system 100 according to the second embodiment with a configuration like the above, in the same and/or similar way as in the first embodiment, is provided with the communication unit 12 and the controller 11. The communication unit 12 is configured to acquire detection sound sampled at each of a plurality of positions. The controller 11 is configured to execute a first classification based on a sound type with respect to at least one sound component included in the detection sound.

The controller 11 is configured to execute a second classification based on a direction of arrival of the sound with respect to at least one sound component included in the detection sound. The controller 11 is configured to extract, from the detection sound, a sound component that corresponds to both a sound type and a direction of arrival identified on the basis of a classification result of the first classification and a classification result of the second classification. Accordingly, the sound extraction system 100 likewise may exhibit an improvement in the precision of isolating a desired sound component.

In the second embodiment, in the same and/or similar way as in the first embodiment, the sound extraction system 100 likewise is configured to relatively adjust the volume of the extracted sound component. Accordingly, this may allow for the sound extraction system 100 likewise to cause the user to perceive a desired sound component distinctly.

In the second embodiment, in the same and/or similar way as in the first embodiment, the sound extraction system 100 likewise is configured to present at least one sound type estimated by the first classification and at least one direction of arrival estimated by the second classification.

The sound extraction system 10 likewise is configured to detect selection input with respect to the presentation of the at least one sound type and the at least one direction of arrival. The sound extraction system 10 likewise is configured to identify a sound type and a direction of arrival in accordance with the selection input. Such a configuration may allow for the sound extraction system 100 likewise to exhibit a further improvement in the precision of isolating a user-desired sound component.

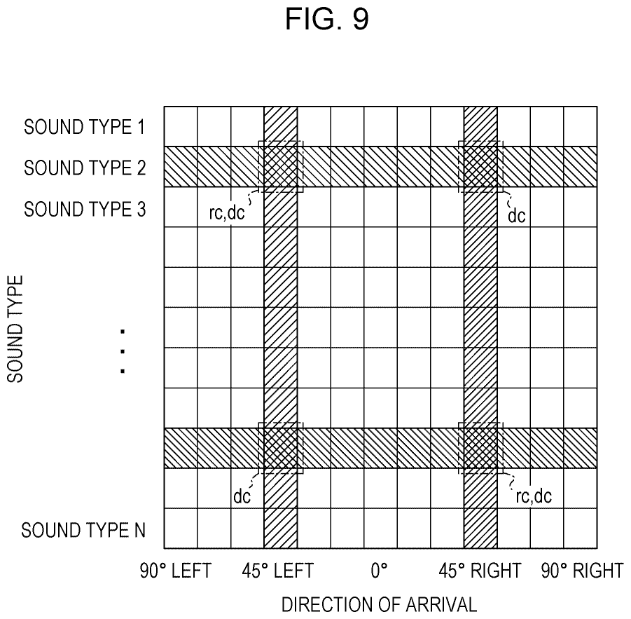

In the second embodiment, unlike in the first embodiment, the sound extraction system 100 is configured to estimate a sound type on the basis of a classification result of the first classification. The sound extraction system 100 is configured to estimate a direction of arrival on the basis of a classification result of the second classification. The sound extraction system 100 is configured to estimate a sound type and a direction of arrival that correspond to the same sound component on the basis of a classification result of the first classification and a classification result of the second classification. The sound extraction system 100 is configured to estimate a sound type and a direction of arrival that correspond to the same sound component on the basis of a joint probability distribution of a sound type that may be classified by the first classification and a direction of arrival that may be classified by the second classification. In a configuration in which the estimation of a sound type of a sound component included in detection sound and the estimation of a direction of arrival of a sound component included in detection sound are performed separately, as illustrated in FIG. 9, if sound components emitted by a plurality of sound sources are included in detection sound, the number of deemed combinations dc of a sound type and a direction of arrival that correspond to the same sound component exceeds the number of real combinations rc that correspond to the same sound component. To cope with such an event, the sound extraction system 100 having the configuration described above is based on a joint probability distribution of sound type and direction of arrival, which allows for an improvement in the precision of estimating a sound type and a direction of arrival that correspond to the same sound component.

In an embodiment, (1) a sound extraction method is
a sound extraction method to be executed by a computer, the sound extraction method comprising:
acquiring detection sound detected by a plurality of microphones;
executing a first classification based on a sound type with respect to at least one sound component included in the detection sound;
executing a second classification based on a direction of arrival of the sound with respect to at least one sound component included in the detection sound; and extracting, from the detection sound, a sound component that corresponds to the sound type and/or the direction of arrival identified on the basis of a classification result of the first classification and a classification result of the second classification.

(2) The sound extraction method according to (1), further comprising:
relatively adjusting the volume of the extracted sound component.

(3) The sound extraction method according to (1) or (2), further comprising:
presenting at least one sound type estimated by the first classification and at least one direction of arrival estimated by the second classification;
detecting selection input with respect to the presentation of the sound type and the direction of arrival; and
identifying the sound type and the direction of arrival in accordance with the selection input.

(4) The sound extraction method according to (3), further comprising:
presenting at least one sound type estimated by the first classification by using a pictorial representation indicating the sound type; and
presenting at least one direction of arrival estimated by the second classification by using a direction range that corresponds to the direction of arrival.

(5) The sound extraction method according to (3), further comprising:
presenting at least one sound type estimated by the first classification and at least one direction of arrival estimated by the second classification by using a table indicating sound types and directions of arrival.

(6) The sound extraction method according to any of (1) to (5), further comprising:
extracting a feature specific to the sound type in the first classification; and
extracting a feature specific to the direction of arrival in the second classification.

(7) The sound extraction method according to any of (1) to (6), further comprising:
estimating the sound type on the basis of a classification result of the first classification; and
estimating the direction of arrival on the basis of a classification result of the second classification.

(8) The sound extraction method according to (7), further comprising:
performing the estimation of the sound type through a comparison between a classification result of the first classification and a classification result of the first classification specific to a given sound type; and
performing the estimation of the direction of arrival through a comparison between a classification result of the second classification and a classification result of the second classification specific to a given direction of arrival.

(9) The sound extraction method according to (7), further comprising:
performing the estimation of the sound type by computing a probability specific to the sound type on the basis of the first classification result; and
performing the estimation of the direction of arrival by computing a probability specific to the direction of arrival on the basis of the second classification result.

(10) The sound extraction method according to (7), further comprising:
estimating the sound type and the direction of arrival that correspond to the same sound component on the basis of a classification result of the first classification and a classification result of the second classification.

(11) The sound extraction method according to (10), further comprising:
estimating the sound type and the direction of arrival that correspond to the same sound component on the basis of a joint probability distribution of a sound type that may be classified by the first classification and a direction of arrival that may be classified by the second classification.

(12) A sound extraction system comprising:
an acquisition unit configured to acquire detection sound sampled at each of a plurality of positions; and
a controller configured to execute a first classification based on a sound type with respect to at least one sound component included in the detection sound, execute a second classification based on a direction of arrival of the sound with respect to at least one sound component included in the detection sound, and extract, from the detection sound, a sound component that corresponds to a sound type identified by the first classification and/or a sound component that corresponds to a direction of arrival identified by the second classification.

(13) A program causing a computer to execute a process comprising:
acquiring detection sound detected by a plurality of microphones;
executing a first classification based on a sound type with respect to at least one sound component included in the detection sound;
executing a second classification based on a direction of arrival of the sound with respect to at least one sound component included in the detection sound; and
extracting, from the detection sound, a sound component that corresponds to a sound type identified by the first classification and/or a sound component that corresponds to a direction of arrival identified by the second classification.

The foregoing describes embodiments of the sound extraction system, but in the present disclosure, an embodiment may also be achieved as a method or program for implementing an apparatus, or as a storage medium (such as an optical disc, magneto-optical disc, CD-ROM, CD-R, CD-RW, magnetic tape, hard disk, or memory card, for example) in which a program is recorded.

An embodiment in the form of a program is not limited to an application program such as object code compiled by a compiler or program code to be executed by an interpreter, and may also be in a form such as a program module incorporated into an operating system. The program may or may not be configured so that all processing is performed solely in a CPU on a control board. The program may also be configured to be implemented, in part or in full, by another processor mounted on an expansion board or expansion unit added to the board as needed.

The drawings used to describe embodiments according to the present disclosure are schematic. The dimensional proportions and the like of the drawings do not necessarily match the real proportions.

The foregoing description of embodiments according to the present disclosure is based on the drawings and examples, but note that a person skilled in the art could make various variations or revisions on the basis of the present disclosure. Consequently, it is to be understood that these variations or revisions are included in the scope of the present disclosure. For example, the functions and the like included in each component and the like may be rearranged in logically non-contradictory ways. A plurality of components or the like can be combined into one, or a single component can be divided.

In the present disclosure, all constituent features described herein and/or all methods or all steps of processes disclosed herein can be combined in any combinations, except for combinations in which these features would be mutually exclusive. Each of the features described in the present disclosure can be replaced by alternative features that work for the same, equivalent, or similar purposes, unless explicitly denied. Therefore, unless explicitly denied, each of the disclosed features is merely one example of a comprehensive series of same or equal features.

An embodiment according to the present disclosure is not limited to any of the specific configurations of the embodiments described above. In the present disclosure, embodiments can be extended to all novel features described herein or combinations thereof, or to all novel methods or processing steps described herein or combinations thereof.

In the present disclosure, qualifiers such as “first” and “second” are identifiers for distinguishing configurations. The numerals denoting the configurations distinguished by qualifiers such as “first” and “second” in the present disclosure are interchangeable. For example, the first image can interchange the identifiers “first” and “second” with the second image. The identifiers are interchanged at the same time. The configurations are still distinguished after the interchange of the identifiers. The identifiers may be removed. The configurations with the identifiers removed therefrom are distinguished by signs. The description of identifiers such as “first” and “second” in the present disclosure shall not be used as a basis for interpreting the order of the configurations or the existence of identifiers with smaller numbers.

1. A sound extraction method to be executed by a computer, the sound extraction method comprising:
acquiring detection sound detected by a plurality of microphones;
executing a first classification based on a sound type with respect to at least one sound component included in the detection sound;
executing a second classification based on a direction of arrival of the sound with respect to at least one sound component included in the detection sound; and
extracting, from the detection sound, a sound component that corresponds to the sound type and/or the direction of arrival identified on the basis of a classification result of the first classification and a classification result of the second classification.

2. The sound extraction method according to claim 1, further comprising:
relatively adjusting the volume of the extracted sound component.

3. The sound extraction method according to claim 1, further comprising:
presenting at least one sound type estimated by the first classification and at least one direction of arrival estimated by the second classification;
detecting selection input with respect to the presentation of the sound type and the direction of arrival; and
identifying the sound type and the direction of arrival in accordance with the selection input.

4. The sound extraction method according to claim 3, further comprising:
presenting at least one sound type estimated by the first classification by using a pictorial representation indicating the sound type; and
presenting at least one direction of arrival estimated by the second classification by using a direction range that corresponds to the direction of arrival.

5. The sound extraction method according to claim 4, further comprising:
presenting at least one sound type estimated by the first classification and at least one direction of arrival estimated by the second classification by using a table indicating sound types and directions of arrival.

6. The sound extraction method according to claim 1, further comprising:
extracting a feature specific to the sound type in the first classification; and
extracting a feature specific to the direction of arrival in the second classification.

7. The sound extraction method according to claim 1, further comprising:
estimating the sound type on the basis of a classification result of the first classification; and
estimating the direction of arrival on the basis of a classification result of the second classification.

8. The sound extraction method according to claim 7, further comprising:
performing the estimation of the sound type through a comparison between a classification result of the first classification and a classification result of the first classification specific to a given sound type; and
performing the estimation of the direction of arrival through a comparison between a classification result of the second classification and a classification result of the second classification specific to a given direction of arrival.

9. The sound extraction method according to claim 7, further comprising:
performing the estimation of the sound type by computing a probability specific to the sound type on the basis of a classification result of the first classification; and
performing the estimation of the direction of arrival by computing a probability specific to the direction of arrival on the basis of a classification result of the second classification.

10. The sound extraction method according to claim 8, further comprising:
estimating the sound type and the direction of arrival that correspond to the same sound component on the basis of a classification result of the first classification and a classification result of the second classification.

11. The sound extraction method according to claim 10, further comprising:
estimating the sound type and the direction of arrival that correspond to the same sound component on the basis of a joint probability distribution of a sound type that may be classified by the first classification and a direction of arrival that may be classified by the second classification.

12. A sound extraction system comprising:
an acquisition unit configured to acquire detection sound sampled at each of a plurality of positions; and
a controller configured to execute a first classification based on a sound type with respect to at least one sound component included in the detection sound, execute a second classification based on a direction of arrival of the sound with respect to at least one sound component included in the detection sound, and extract, from the detection sound, a sound component that corresponds to a sound type identified by the first classification and/or a sound component that corresponds to a direction of arrival identified by the second classification.

13. A program causing a computer to execute a process comprising:
acquiring detection sound detected by a plurality of microphones;
executing a first classification based on a sound type with respect to at least one sound component included in the detection sound;
executing a second classification based on a direction of arrival of the sound with respect to at least one sound component included in the detection sound; and
extracting, from the detection sound, a sound component that corresponds to a sound type identified by the first classification and/or a sound component that corresponds to a direction of arrival identified by the second classification.
